(19) United States
(12) Patent Application Publication
(10) Pub. No.: US 2014/0057081 A1
(43) Pub. Date: Feb. 27, 2014

(54) DEVICE, COEXTRUSION NOZZLE, AND METHOD FOR APPLYING AND/OR PRODUCING A PLANAR MATERIAL COMBINATION

(71) Applicant: Josef Rothen, Solingen (DE)

(72) Inventor: Josef Rothen, Solingen (DE)

(73) Assignee: RWR Patentverwaltung GbR, Solingen (DE)

(21) Appl. No.: 14/110,932

(22) PCT Filed: Apr. 12, 2012
(86) PCT No.: PCT/EP2012/001585

§ 371 Date: Nov. 4, 2013

(30) Foreign Application Priority Data
Apr. 12, 2011 (DE) 102011019761.7

(51) Int. Cl. B29D 7/01; C09J 7/02

(52) U.S. Cl. CPC B29D 7/01; C09J 7/02
USPC 428/161; 425/133.5; 264/172.19; 428/343; 428/212; 428/347

(57) ABSTRACT

The invention relates to a device for producing and/or applying a substantially planar material combination which is formed from at least two surface regions and has a predefined combined width, combined height, and/or combined length. Said device comprises a conveying unit that defines a direction of travel and has a conveying surface. The device also comprises an application unit including an application nozzle which has a slit-shaped outlet extending substantially transverse to the direction of application and which allows the first surface region made of a first extrudate and the second surface region made of a second extrudate to be extruded onto the conveying surface. The application nozzle (8) comprises at least one conveying unit (22; 22′) for conveying an extrudate onto the conveying surface. The conveying unit allows the conveyed volume, the conveyed mass, the conveying speed, and/or the conveying time of at least one of the extrudates to be controlled.

### FIELD OF THE INVENTION

The invention relates to a device for producing and/or applying an essentially two-dimensional composite formed of at least two areal regions in predeterminable composite width, predeterminable composite height and/or predeterminable composite length, as classified in the preamble of claim 1. So the device comprises an applicator appliance which includes an applicator die. The applicator die comprises a slot-shaped outlet disposed essentially transversely to the application direction whereby the applicator die is formed as a wide-slot die permitting an application width which is distinctly greater than the application caliper/thickness or height. The device also comprises a transporting appliance which includes a transport area. Application is possible onto the transport area, the applied material being transported away by the applicator device. The transporting appliance defines within the device a transport direction into which the transport area/the composite produced are transportable. The transporting appliance can also be formed by a movable substrate or by a movable carrier, to which the areal regions of the composite can be applied. Substrates of this type can also be release liners. Alternatively, the composite may comprise the substrate/release liner.

### TECHNOLOGICAL BACKGROUND

There are devices in the prior art to produce two-dimensional composites via extrusion processes. Devices of this type comprise extrusion dies which optionally superpose two or more layers of different materials, for example different polymers. The materials are fed into the extrusion die by one or more (screw) extruders, predominantly into the center of the die, such as a wide-slot die. The formation of a predetermined stacked or layered configuration of the multilayered composite requires the components to be extruded (i.e. the extrudates) to have a distribution which is generally achieved when the internal construction of the die includes a plurality of die components which are sometimes costly and inconvenient to produce and clean. It has become established practice to dispose one or more barriers inside the die to supposedly influence the exiting of the extrudates out of the die as a way to influence the flowability of extrudates which flow into the die at differing viscosity. Dies of this type preferably have a contour resembling that of a coathanger. Barriers of this type are alternatively useful for controlling the transverse distribution of the extrudates within the die.

To ensure very uniform application of extrudates exiting from an extrusion die, the dimensions of the exit orifice are generally conformed via tensile and compressive bolts. In addition, pins disposed in the region of the exit orifice can be intentionally heated or cooled to conform the flow properties of the extrudate to the layer requirements.

The problem with production processes for generating composite materials having a plurality of areal regions or layers via extrusion dies of this type is that an alteration to the parameters of the composite material, for example an alteration to individual region or layer dimensions, will always necessitate a revamp or even complete replacement of the production device/extrusion die.

### SUMMARY OF THE INVENTION

Against this background, the invention has for its object to specify measures for fabricating preferably adhesive composite materials whereby the specifically equipment-based production requirements are reduced in relation to the prior art such that the functional properties of the composite material are not impaired.

This object is achieved by a device as defined in claim 1. According to that, the applicator die comprises at least one conveying appliance for conveying an extrudate onto the transport area. The conveyed volume, the conveyed mass, the conveyance velocity and/or the metering time of at least one of the extrudates is controllable using the conveying appliance. A possible alternative is a twin-orifice die where the die slot comprises two mutually opposite slotted segments. The die slot length of the applicator die determines virtually the maximum composite width of the composite. The composite exiting from the applicator appliance, in particular from the applicator die, can be applied to the transporting appliance. The composite can be applied to a transport area of the transporting appliance.

The transport area is conveyable in the transport direction. It can be advantageous for the composite exiting from the applicator appliance to be applicatory to a substrate which is conveyable in the transport direction by the transporting appliance in particular. The substrate can for this be disposed on the transport area of the transporting appliance. However, the transporting appliance may also be formed of the substrate or comprise the substrate. The substrate may comprise a plurality of substrate portions in that, for example, the substrate or the substrate portions may be formed of a foil material, a fibrous material or a wallpaper. The substrate can be disposed on a roll or roller or be unwindable therefrom. Alternatively, the substrate can be constituted, especially cut, such that it is unstackable from a support surface.

The conveying appliance may comprise at least one pump for conveying an extrudate. The pump or pumps may be assigned at least one drive. It is particularly advantageous for the conveying appliance to comprise at least one switch element. The switch element may include at least one valve and/or at least one return line so that the extrudate conveyed by the conveying appliance is circulatable/can be circulated within the applicator appliance or within the conveying appliance.

The areal regions within the composite can be disposed side by side or on top of each other. When the areal regions are disposed on top of each other, the composite has at least portionally a layer-type construction, i.e., the areal regions have essentially parallel sheetlike dimensions and are in face-to-face contact with each other.

At least one of the areal regions of the composite can be formed of an adhesive, especially a hot-melt adhesive. Preference is given to pressure-sensitive adhesives (PSAs), optionally based on an elastomer. The layer of adhesive may comprise an ethylene-vinyl acetate (EVA) and be solventless. However, the adhesive can also be activatable by a solvent, for instance water. There are likewise areal regions comprising radiation-curable adhesives such as, for instance, UV acrylates, and also moisture-crosslinkable adhesives such as polyurethane (Polyurethane Reactive, PUR) or polyolefin (Polyolefin Reactive POR).

Two-dimensional composite materials of this type have at least one or more adhesive areal regions, or adhesive layers, and can be used in adherent coatings or as a packaging article constituent, for example.

The applicator appliance can, if necessary, be heatable whereby the heat-liquefiable extrudates change their flow properties. Optionally, the transporting appliance may include a transportation belt whose surface forms the transport area. This transportation belt can be endless. Alternatively, the transport area can also be curved, as would be the case for example when the transporting appliance comprises a transport roller. The application of material can be for example directly onto the transport area. It can be advantageous in this case for the transport area to have a coating, in particular an anti-stick coating. The anti-stick coating can be formed of a silicone and/or comprise a silicone. The purpose of the anti-stick coating of the transport area/transportation belt is that the composite applied to the transport area is easier to remove.

The two-dimensional composite is preferably applied such that the composite length of the composite is essentially parallel to the transport direction and thus also to the transport area. The composite width of the composite at the same time is vertical or almost vertical to the transport direction. Ideally, the composite length and the composite width combine to define a plane which is parallel to or within the transport area. The composite height of the composite is essentially perpendicular to the transport area, i.e., it is essentially vertical to the composite length and to the composite width.

Advantageously, the coextrudate leaving the applicator die is formed as a vertical or almost vertical falling curtain onto the transporting appliance or onto a substrate conveyable on the transport area in the transport direction. The extrudate curtain touches the transport area/substrate, and so the movement of the transport area/substrate in the transport direction leads to an at least film-type application of material being formed on the moving transport area/substrate. The areal regions may form layers of the composite which are disposed one on top of the other, i.e., stacked on top of each other, along the composite height. Alternatively or additionally, the areal regions can be disposed side by side in relation to the transport direction, i.e., as neighboring areal regions. To exert a mechanical pressure on the extrudates/coextrudate, especially on the falling curtain, the extrudates can also be fed to a roll or into the nip between a pair of rolls. At least one roll may be additionally cooled especially when one of the extrudates comprises polyethylene (PE).

The applied material or the film of material forms the composite to be produced and to be applied, respectively, while it can be advantageous for the transporting appliance and/or the transport area to be coolable. The transporting appliance can in this case be assigned a cooling appliance whereby the liquid (molten) film of material formed of the coextrudate is coolable. Alternatively, the coextrudate can also be applicatory to the transporting appliance/substrate directly, without formation of an extrudate curtain.

Optionally, the cooling appliance can include a cooling belt which is electrically coolable, for example. The cooling appliance/belt renders the transport area and/or a substrate conveyable on this transport area at least portionally coolable. The liquid and heated assembly exiting from the usually heated or heatable applicator appliance/die cools down on the transporting appliance as a result of the effect of the cooling appliance and/or changes into an essentially solid or at least more viscous state. When one or more applied extrudates are, for example, hot-melt adhesives, these can be hardened by the cooling appliance, rendering them simpler to remove from the transporting appliance and subsequently further processable. Belt cooling is known inter alia from DE 198 00 683 B4.

According to the present invention, the composite width and/or the composite length and/or the composite height are adjustable with the applicator die of the applicator appliance of the device for applying and/or producing a two-dimensional composite. In addition, the transporting appliance can be involved in adjusting the composite length and/or the composite width and/or the composite height in that the transport speed of the transporting appliance may be controlled, especially switched on and off.

To adjust the composite length of the composite, for example, the applicator die is briefly deactivated during application. This interrupts the application of the composite onto the moving transporting appliance and/or onto the substrate conveyed on the moving transport area. The composite length of the composite can be determined by varying the time for interruption or deactivation while keeping a constant speed of transport. The composite height of the two-dimensional composite can be altered and thus adjusted by increasing or reducing the feed rate of the extrudates in the die which are used for forming the composite while keeping a constant speed of transport for the transporting appliance. A quantitatively high throughput of extrudates through the applicator die leads to a greater composite height on the part of the composite, i.e., the composite becomes thicker as a result. Adjusting the composite width of the composite can be effected, for example, by the exit width of the die slot of the outlet of the die being alterable via at least one slider disposed in the coextrusion channel, as known from DE 100 23 895.5. The individual zone portion of a wide-slot die, which are each assigned one conveying appliance, are connectable and disconnectable via feed interruption.

In a particularly preferred embodiment of the device according to the present invention, the areal region width, and/or the areal region length and/or the areal region height of at least one of the areal regions, preferably of each and every areal region, of the composite is at least portionally adjustable via the applicator die. In effect, the areal region width, the areal region height and/or the areal region length of any one areal region is adjusted such that the areal region width, areal region height and areal region length of whichever is the other areal region are not affected. For instance, the feed rate of the first extrudate, which forms the first areal region of the composite, can be varied to increase the areal region height of the first areal region, making the first areal region thicker. Conveyance of the second extrudate is not affected by this, so the second areal region retains its properties and its dimensions. It is accordingly possible for the properties, especially the length, width and height, of the second areal region whereonto the first areal region can be applied to be left entirely unaltered.

It is alternatively also possible, where necessary, for the properties of both the areal regions forming a specifically two-layered composite wherein the two areal regions each form a layer of the composite to be altered and appropriately adjusted. This can selectively be done portionally or across the full composite width, composite length or composite height. Owing to this cornucopia of variation possibilities, it is possible to produce layer or areal region configurations in any design without the device of the present invention having to be revamped or even a die of the applicator appliance of the device having to be replaced. Hence there is also no need to idle the device for the purpose of revamping or replacing a component. Depending on the constitutional and configurational requirements of the two-dimensional composite to be produced, there is merely a need to alter the operational settings of the device. These operational settings, in relation to the flowability of the extrudates for example, relate to the amounts, pressures and temperatures of the extrudates conveyed through the die, or regions of the die, the control of regions of the die which are involved and also the speed and, where applicable, the cooling temperature of the transporting appliance.

A melt-type adhesive may be concerned with one or more extrudates, especially a hot-melt adhesive. The melt-type adhesive may comprise base polymers, such as polyamides (PA), polyethylene (PE), amorphous poly-a-olefins (APAO), ethylene-vinyl acetate copolymers (EVAC), polyester elastomers (TPE-E), polyurethane elastomers (TPE-U), copolyamide elastomers (TPE-A), vinylpyrrolidone-vinyl acetate copolymers and others. As for the rest, the melt-type adhesive may contain resins, such as rosin, terpenes and/or hydrocarbonaceous resins and similarly stabilizers such as antioxidants, metal deactivators and/or photoprotectants, and also, optionally, waxes, such as natural waxes (beeswax) and/or synthetic waxes (wholly synthetic, partly synthetic, chemically modified).

The apparatus requirements involved in the production of specifically adhesive composite materials is also reduced by the invention through a coextrusion die as defined in claim 6. The coextrusion die provided is accordingly for generating and/or applying a two-dimensional applied material, formed of a coextrudate, of a composite material comprising a first areal region formed of a first extrudate and a second areal region formed of at least a second extrudate. The coextrusion die of the present invention comprises a first inlet for the first extrudate and a second inlet for the second extrudate. It further comprises an outlet for the coextrudate, i.e., the combination of both the extrudates merged in the die. The outlet is preferably disposed on the underside of the die, so that the coextrudate exits the coextrusion die under the agency of the pressures of the extrudates conveyed in the die and, where applicable, under the force of gravity. Alternatively, the coextrudate can be given an exit speed determinable via the conveyance of the extrudates through the die.

The invention here provides that the coextrusion die comprises at least one integrated conveying appliance which is in fluidic communication with one or more inlets. The conveying appliance is capable of conveying at least one extrudate through the coextrusion die to the outlet. The conveyed volume, the conveyed mass, the conveyance velocity and/or the metering time of at least one of the extrudates is controllable with the conveying appliance.

The width of the applied material leaving the outlet may preferably be alterable, in which case the width of application is not more than the maximum width essentially fixed by the width of the outlet. Application width is thus not more than the maximum width fixed essentially by the width of the outlet.

Preferably, the second inlet is also fluidically connected to at least one conveying appliance which is likewise a constituent part of the coextrusion die according to the present invention. It is advantageous for each and every one of the conveying appliances of the coextrusion die to comprise at least one pump and at least one switch element such as, for instance, a valve. The conveying appliance may also comprise at least one fluidic return line leading back into the line leading to the pump and formed by the switch element as switchable line to return the extrudate. Pump speed can be alterable to control the feed rate and be controllable via at least one pump drive. The pump may optionally be assigned a drive. A plurality of pumps can be advantageous for a plurality of conveying appliances, and they can be assigned either a conjoined controllable drive or a plurality of individually controllable drives.

It can further be possible to use the conveying appliance to interrupt the conveyance of one or more of the extrudates through the coextrusion die without disrupting and altering the flux/pressure of the extrudates in the feed systems or lines assigned to the inlets.

The extrudate retains its flow properties through the return line even though the flux through the coextrusion die can be interrupted. To retain the flow properties of the extrudates, these are then further conveyed within the conveying appliances in a circulating manner. This retention of the flow properties of the extrudates is achieved as a result of a switch element being disposed upstream of the inlet to divert, in the event of a desired interruption of the conveyance of the extrudate through the coextrusion die, the extrudate flux upstream of the inlet into a return line or a return channel which, viewed in the flux direction, leads back into the feed line upstream of the pump of the conveying appliance. The requisite pressure of the extrudates is essentially retained as a result, avoiding any undesirable bubbling in the applicator appliance of the device according to the present invention. This incidentally also ensures that in the event of an alteration to the switch position of the valves of the conveying appliances for example to continue the coextrudate application, the coextrudate film leaving the outlet does not tear off because the pressure of the extrudates is not kept essentially constant in the applicator device. An interruption of the application of the extrudate for instance onto the transporting appliance can accordingly be effected by actuating the switch element and subsequent circulation of the extrudate within the applicator/conveying appliance. Continuation of application for instance after an interruption of application can be effected by renewed actuation of the switch element whereby the extrudate no longer circulates in the applicator appliance but is again conveyable in the direction of the outlet from the applicator die.

Alternatively, the extruder provided for conveying the extrudate into the applicator appliance and connected to one or more of the inlets can adapt, especially reduce, its conveyance velocity to the altered overall feed quantity.

Application due to the coextrusion die can be effected portionally, so that the portions of the material applied to the transport area and/or to a substrate conveyed on the transport area have specifically strip-shaped interruptions. The strip-shaped interruptions can selectively be essentially parallel to the transport direction or essentially transverse to the transport direction. It can also be advantageous for the interruptions to be at an angle to the transport direction and/or angled. When the interruptions to the two-dimensional application of material are parallel to the transport direction, the consequence is that the material applied to the transport area has strip- or web-shaped portions with or without lateral separations relative to each other. By interrupting the application of material essentially transversely to the transport direction it is possible to restrict web-shaped portions of the applied material in their length.

The interruptions can in other respects vary at least portionally in their width and/or in their length—in each case based on the composite width and length. This results in composite dispositions having at least one offset of an areal region portion relative to some other portion. The offset can be oriented longitudinally or laterally, based on the dimensions of the composite.

Preferably, the coextrusion die of the present invention may comprise a coextrusion channel which is disposed in a housing of the coextrusion die. The first and second inlets for the first and second extrudates empty into the coextrusion channel. The outlet for the coextrudate is connected to the coextrusion channel. It is advantageous for the coextrusion channel to extend essentially parallel to the length dimension of the die slot.

The coextrusion die may preferably comprise at least one slider disposed in the coextrusion channel to alter the width of the outlet and/or the composite width and/or of at least one portion of the composite.

The design of the coextrusion die with an integrated coextrusion channel enables the second inlet to empty into the coextrusion channel such that the second extrudate can be disposed on an extrudate surface formed by the first extrudate. It is accordingly possible to direct the second extrudate against an extrudate surface formed by the first extrudate. When the extrudates are, by way of example, formed of specifically molten, for instance previously heated, adhesives, the face-to-face disposition of the second extrudate on an extrudate face formed by the first extrudate will have the effect that the extrudate surfaces are adherent to each other not just because of their as yet unsolidified state. As it is being conveyed, the first extrudate carries the second extrudate.

A dividing wall may preferably be disposed in the coextrusion channel to separate the first inlet and the second inlet from each other. The dividing wall can be disposed such that it extends essentially parallel to the slot-shaped outlet of the coextrusion die. The dividing wall can have the effect that the extrudates conveyed through the first and second inlets can be conveyed within the coextrusion die, especially within the coextrusion channel, at least regionally such that the extrudates do not come into contact with each other. This can avoid extrudate commixing due to turbulent flow in regions of the die, for example.

A particularly advantageous design of the coextrusion die comprises a plurality of coextrusion chambers which are disposed in the coextrusion channel or in the region of the coextrusion channel and, more particularly, are disposed side by side in relation to the width of the die. In relation to the width direction of the die, the coextrusion channel is for example subdivided by the coextrusion chambers into a plurality of volume regions adjacent to each other and separated from each other. The chambers can be separated from each other by struts or chamber walls. Alternatively or additionally, there may be provided coextrusion chambers mutually opposite each other relative to the transport direction. The coextrusion chambers can subdivide specifically the coextrusion channel, or the coextrudate outlet connected to the coextrusion channel, into widthwise portions of the wide-slot die which define the width of the portions of the wide-slot die which are involved in the application of the composite.

A coextrusion die comprising a plurality of coextrusion chambers is particularly advantageous when each and every coextrusion chamber of the coextrusion channel of the coextrusion die is in fluidic communication with a first conveying appliance for the first extrudate and a second conveying appliance for the second extrudate, all conveying appliances being a constituent part of the coextrusion die. When these two or more conveying appliances are each assigned a pump, the two or more pumps can be formed as multistaged pumps which optionally are assigned to a drive. However, a pump and a pump drive may also be provided for each and every conveying appliance. The conveyed quantity of the first extrudate and/or of the second extrudate through each and every one of the coextrusion chambers can be controlled. With regard to the configuration of material to be applied using the coextrusion die of the present invention, the properties of the entire application can accordingly be varied portionally by altering the conveyed quantity of the particular extrudate through the coextrusion chamber involved at the particular portion. The alteration in the conveyed quantities through the device of the present invention takes place so delaylessly that the portional variation and/or interruption to the conveyance takes place with very high accuracy in that a very clean partition can be achieved between the applied portions.

For example, the composite width of the composite can be altered by connecting and/or disconnecting one or more of the conveying appliances which are fluidically assigned to one or more coextrusion chambers disposed edge-sidedly in relation to the width of the outlet. By connecting and/or disconnecting all the conveying appliances it is similarly possible for the composite length of the composite to become alterable. When, for example, the conveyance of the first and second extrudates of an essentially centrally disposed coextrusion chamber is alternatively stopped or disrupted, this leads in effect to an application of material having two band-type portions disposed adjacent to each other on an application area. Appropriate connecting and disconnecting of the conveying appliances of individual coextrusion chambers can be used to form a multiplicity of regular or irregular patterns for the application of the material. Application can be, in particular, intermittent, i.e., with regional or portional interruptions or with temporal interruptions of the conveyed quantity of the extrudate(s). Regional interruptions concern for example those interruptions which extend across a region of the composite length, the width of which is preferably equal to the entire or almost the entire composite width.

The transverse distribution accuracy, i.e., the accuracy with which the composite width of the composite, or the layer width of the extrudate layers or portions of the layers, is achieved, can essentially be attained via the conveying appliance(s) of the die. This appreciably reduces the tooling required to manufacture the die or individual die components. A high longitudinal distribution accuracy, relating to the composite length in particular, is obtained in an analogous manner.

Alternatively, one or more mobile sliders may be disposed in the coextrusion die, especially in the region of the coextrusion channel, to alter, for instance by way of preliminary adjustment, the width of at least one outlet portion involved in the application. This provides for continuous adjustability/alterability of the width of the die slot portion involved in the application and/or of at least one portion of the applied material.

The design of the coextrusion die where each and every coextrusion chamber of the coextrusion channel is assigned first and second conveying appliances for the first and second extrudates additionally enables the layered configuration of the applied material to be alterable with respect to individual layers. When, for example, the conveyed quantity of the first extrudate through an essentially centrally disposed coextrusion chamber of the coextrusion channel is temporarily reduced or interrupted, the result would be that the first layer of the applied material will have a weakening/interruption in the region of the center of the applied material. This weakening can for example have the purpose of endowing the composite, in the region of the weakening, with a predetermined breaking or flexing point or—in the case of extrudates forming adhesive—suppressing the adhesive property, as per the example, in the central region of the entire application of material. Alternatively, a multiplicity of patterns and layered configurations solely through varying the conveyed quantity/feed rate—through varying the pump speed and the operational setting of the switch element, for instance—of either or both of the extrudates through one or more of the coextrusion chambers involved are also conceivable here.

When the first and second areal regions of the two-dimensional composite which can be applied through the coextrusion die of the present invention each have an areal region width and an areal region length which define a plane parallel to an application area and when the first and second areal regions each have an areal region height extending essentially perpendicularly to the application area, it can be advantageous for each and every one of the conveying appliances to be assigned a control appliance. As a result, each and every one of the conveying appliances is separately and preferably mutually independently controllable, especially open and closed loop controllable. The areal region width, the areal region length and/or the areal region height of one or more areal regions involved in the application of material is thereby alterable, in particular portionally/regionally. The control appliances can alternatively lead to a central control unit where all parameters with respect to composite length, composite width and composite height of the entire composite and also the areal region length, areal region width and areal region height (areal region thickness) of each and every one of the areal regions involved is selectable and the parameters can be changed during application. The fabrication of different composite materials or the fabrication of a composite having a spatially changing areal region or layered structure does not require redesign, revamping or replacement of the coextrusion die. This greatly reduces the equipment requirements for producing two-dimensional multilayered composite materials while at the same time greatly improving the diversity of functional properties for the composite material to be produced.

To liquefy the extrudates, the coextrusion die of the present invention may comprise a heating device which can be assigned to the first inlet and/or to the second inlet. The heating device may preferably be operated electrically and may be configured, by way of example, as a heating collar disposed around a feed line to the inlet. The heating collar can also be disposed around one or more pumps of the conveying appliance. The heating power output imparted to the extrudates correlates with the temperature of the extrudates and can be a further parameter to influence the application properties of the coextrusion die. For instance, an increase in the heating power output may result in the extrudate in question being conveyable at a lower viscosity, and thus at a higher speed, through the coextrusion die.

Alternatively or additionally, the outlet of the coextrusion die can be heatable. It is particularly advantageous for the outlet and/or the coextrusion channel of the coextrusion die to be heatable.

It can be advantageous for the coextrusion die to comprise at least one pressure sensor to monitor the pressure, i.e., the admission pressure to be precise, of at least one extrudate. Alternatively, the pressure sensor can be connected to at least one extruder to determine the admission pressure. The pressure sensor can alternatively be assigned to the coextrusion chamber and/or one of the inlets to monitor the pressure of at least one extrudate.

Measures to reduce the apparatus requirements in the production of multilayered two-dimensional composite materials without impairing the functional properties of the composite material are also extractable from a process according to claim 18 of the present invention. Said process is accordingly one for applying and/or producing a two-dimensional multilayered composite on a moving transport area of a transporting appliance or on a moving substrate. The composite is formed in the process from an applied material which includes a first areal region and at least one second areal region. The composite preferably has a composite width and a composite length which combine to define a plane which is essentially parallel to an application area. The composite has a composite height which is essentially perpendicular to the application area. Each and every one of the areal regions of the composite which are involved in the application of material is characterized by an areal region length, an areal region width and an areal region height.

The process provides according to the present invention that the composite is coextruded from a first extrudate forming the first areal region and at least one second extrudate forming the second areal region while the areal region widths and/or the areal region lengths and/or the areal region heights of the first and/or of the second areal region and/or the composite width, and/or the composite length and/or the composite height of the composite are altered during the coextrusion by the delivered quantity of the first and/or of the second extrudate being altered at least portionally in a preferably controllable manner More particularly, the delivered mass and/or the delivered mass per unit time and/or the delivered volume and/or the delivered volume per unit time of the first and/or of the second extrudate are altered at least portionally and/or at least temporally in a preferably controllable manner.

The process obviates the need to revamp or replace device components involved in the process. On the contrary, the process makes it possible to control the coextrusion parameters such that the composite materials produced according to the process have properties in keeping with the intended use, functions in keeping with the intended use and effects in keeping with the intended use. Said properties, functions and effects in keeping with the intended use of the composite materials to be applied are essentially determined by the composition and by the dimensions of the applied material and also by the dimensions of the areal regions involved in the application. If, for example, the production of a comparatively thin composite is to be followed by the production of a composite which by comparison therewith is thick or at least thicker, this merely requires the controllable alteration of the process parameters and settings involved in the coextrusion. There is accordingly no need to redesign the device components involved in the application or to replace involved components.

A further measure to avoid intensive cost/inconvenience in the production of two-dimensional multilayered composite materials is extractable from a further process as claimed in claim 19. In said process, the composite formed of two extrudates is coextruded such that, in a coextrusion die having a coextrusion channel, the second extrudate is conveyed against the extrudate surface of the first extrudate conveyed into the coextrusion channel By the second extrudate being conveyed against the surface of the first extrudate, the second extrudate becomes adherently placed onto the first extrudate. This is particularly advantageous when the first areal region formed of the first extrudate is thicker than the second areal region (of the composite) formed of the second extrudate. By the second (thinner) areal region being directed against the first (thicker) one, the first areal region comes into contact with the second one at the conveyance velocity of the first areal region, and so it is sufficient to convey the second areal region up to the point where the two areal regions become placed against each other, in particular adherently.

Both the processes make it possible to produce a composite which can be used off-line without a carrier medium. “Off-line” is to be understood in this context as meaning that the composite is produced first, before it is further used outside the production process and there is no intention in this further use to dispose the composite on a carrier medium.

It can be advantageous for the processes of the present invention to be designed such that the areal region width and/or the areal region length and/or the areal region height of one of the areal regions is altered while the areal region width, the areal region length and the areal region height of at least one of the other areal regions are retained. The composite materials generated with this process are notable in that the second areal region, for example, has constant sizes across the four dimensions of the material applied to produce a composite, whereas the second areal region applied to the first areal region is either merely applied portionally or weakened regionally. When, for example, either or both of the areal regions involved comprises a hot-melt adhesive, the result can be in effect that the consistently applied first areal region endows the composite with weakly adherent properties throughout, whereas those regions where the second areal region has been applied have strongly adherent properties.

Especially when the extrudates involved in the application of the material are hot-melt adhesives, the processes of the present invention may advantageously be designed such that the transporting appliance and/or the transport area is at least portionally cooled. Cooling the transport area causes the hot-melt adhesive to at least partially harden and hence possibly deactivate, facilitating the detachment of the composite from the transport area.

Alternatively, a substrate can be provided for the composite by applying the coextrudate to a removable substrate carried on the transporting appliance. This causes the composite to become bonded to the substrate in-line, i.e., during its production, especially adherently; subsequent disposition of the composite on a substrate or carrier is made unnecessary as a result.

The apparatus requirements for producing multilayered, specifically adherent, composite materials are otherwise reduced when the composite to be produced is designed according to claim 24. According to that, the two-dimensional composite consists of a first areal region and at least one second areal region disposed on the first areal region. The first areal region is formed of a first extrudate and the second areal region is formed of a second extrudate, so that the areal region composite comprising the first and second areal regions is formed of a coextrudate which is preferably obtainable using a coextrusion die of the present invention. According to the present invention, the two-dimensional composite comprises a second areal region formed of a function layer such as, for instance, an adhesive layer and also a first areal region formed of an effect layer. The coextruded areal regions of the composite according to the present invention are obtainable with distinctly lower apparatus requirements than hitherto customary. Thus, to form different composite materials differing in their regional layered structures in particular does not require a swap of necessary apparatus components or an apparatus revamp.

The effect layer may optionally have adhesive properties as well as volume-filling, acoustically damping and/or mechanically damping properties. The effect layer may alternatively also be a flameproofing layer having flameproofing properties or a barrier layer having a barrier property. The disposition of the function or adhesive layer on an effect layer leads to a two-dimensional composite wherein the function layer can be distinctly thinner than the effect layer.

It may alternatively also be provided that the areal region width and/or the areal region length and/or the areal region height of the first and/or second areal regions varies at least portionally across the composite length and/or the composite width and/or the composite height of the composite. The first and second areal regions here are each defined by the areal region width, the areal region length and the areal region height.

The first and second areal regions of the composite according to the present invention can be formed of different materials, in particular of different adhesives. The first and second layers may preferably be formed of reactivatable hot-melt adhesives comprising for example polyurethane (PU), ethylene-vinyl acetate (EVA) or a UV-acrylate.

Preferably, the effect region augments the property of the function region; in particular the adhesive property of the function region is augmented by the effect region. The augmentation can be mechanical or chemical in kind. For example, the effect region can even out surface unevennesses to improve, and thus augment, the adherence of the function region.

The first and second areal regions here may have the same or almost the same areal region height. Alternatively, the first areal region can have a different areal region height than the second areal region, in which case the first areal region is preferably thicker than the second areal region. The thicker design of the first areal region enables it to better penetrate into surface unevennesses to enlarge the effective contact area between the composite according to the present invention and the adherend surface. This improves the adherence.

With an eye to further processing the composite of the present invention, the second areal region and the first areal region disposed on the second areal region may be disposed on a substrate which can selectively be greater and/or thicker (higher) than the composite. This substrate may be formed of an organic material or of an inorganic material. Combinations of an organic material with an inorganic material are also conceivable. Preferably, the substrate is formed of a plastic or a polymeric foil, for example comprising polyethylene (PE). Substrates comprising paper, cardboard, fibrous materials or combinations thereof are also conceivable.

It is advantageous for the first and/or second areal regions to be formed of a hot-melt adhesive which is preferably chemically or radiation-crosslinkable, reactivatable, durably tacky and/or water-soluble.

An alternative design for the areal region according to the present invention comprises a substrate or comprises a carrier material whereon the first areal region and the second areal region disposed above the first areal region are disposed. The substrate can be formed of an organic material or of an inorganic material or of a combination thereof, in particular of a plastic, a polymeric foil, a paper, a cardboard article, a fibrous material or combinations thereof.

The composite is particularly advantageous when the first and second areal regions are disposed between the substrate and a third areal region which is preferably at least portionally disposed on the second areal region. Hence the composite comprises four layers or plies, of which the fourth layer, or to be more precise the third areal region, can be formed for example of a plastic or a fibrous material.

The aforementioned parts to be used according to the present invention, the claimed parts to be used according to the present invention and the parts to be used according to the present invention which are described in the exemplary embodiments are not subject to any special exceptional conditions in respect of their size, shape, choice of material and technical conception, so the familiar selection criteria in the field of application can find unreserved application.

Further details, features and advantages of the subject matter of the invention will be apparent from the dependent claims and also from the description hereinbelow and the related drawing which depicts, by way of example, an exemplary embodiment of a device for producing and/or applying a two-dimensional composite, of a coextrusion die for applying the two-dimensional composite and also of a two-dimensional composite. Even individual features of the claims or embodiments can be combined with other features of other claims and embodiments.

### BRIEF DESCRIPTION OF THE FIGURES

In the drawing

FIG. 1A shows a device for producing and/or applying a two-dimensional composite 3 in a schematic side view;

FIG. 1B shows an applicator appliance in side view;

FIG. 2 shows a plan view of a device as per FIG. 1 (schematic);

FIG. 3 shows a schematic depiction of a coextrusion die 8 for applying a composite 3;

FIG. 4 shows a detailed view of a coextrusion die 3 in a schematic sectional depiction;

FIG. 5 shows a perspective depiction of a composite 3 (schematic);

FIG. 6 shows a composite 3 in vertical section (schematic);

FIG. 7 shows an alternative design of a composite 3 in vertical section (schematic);

FIG. 8 shows a design of composite 3 on a substrate 13 in vertical section (schematic);

FIG. 9 shows a schematic plan view of a composite 3; and

FIG. 10 shows a four-ply design of composite 3 (schematic).

### DETAILED DESCRIPTION OF EXEMPLARY EMBODIMENTS

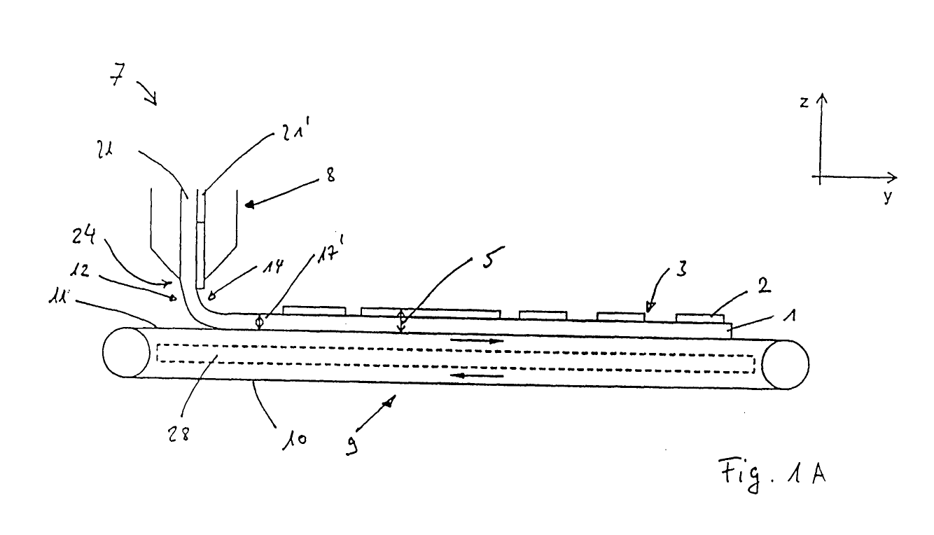

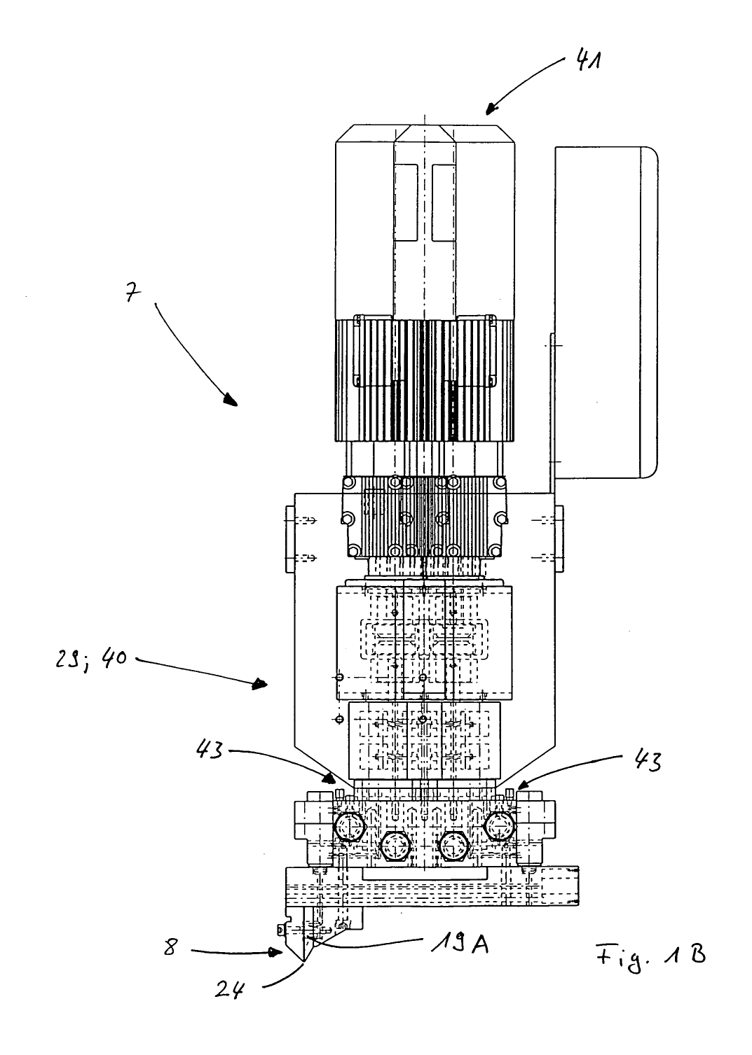

FIG. 1A reveals a schematic view of a device for producing and/or applying an essentially two-dimensional composite 3 formed of at least two areal regions 1, 2 in predeterminable composite width 4, predeterminable composite height 5 and/or predeterminable composite length 6. The areal regions 1, 2 each form a layer 1, 2 of the composite 3. The device includes an applicator appliance 7 which comprises an applicator die 8. A transporting appliance 9 is disposed underneath the applicator die 8, which is formed as a coextrusion die. The transporting appliance 9 is formed as a transportation belt 10 which has a transport area 11 on the topside of the belt 10. Owing to the transporting appliance 9, the transport area 11 can move in transport direction y under the spatially fixedly disposed coextrusion die 8. The falling curtain 12 coming out of the coextrusion die 8 in a virtually vertical direction z can be applied to the transporting appliance 9 in the region of transport area 11. The composite 3 can preferably be applied to a substrate 13 which lies on the transport area 11 and is conveyable in transport direction y using the transporting appliance 9.

The transportation belt 10 as per FIG. 1A can be formed as a cooling belt which comprises a cooling appliance 28. As a result, the generally hot, viscid or molten coextrudate 14 exiting from the coextrusion die 8 is cooled on the transporting appliance 9, causing the composite 3 to at least partially harden and/or change its viscosity.

The device as per FIG. 1A makes it possible to adjust the layer width 15 and/or the layer length 16 and/or the layer height 17 of at least one of the layers 1, 2/areal regions 1, 2 of the composite 3 portionally. This is effected by varying the coextrusion parameters within the coextrusion die 8.

A side view of an applicator appliance 7 having a coextrusion wide-slot die 8 is discernible from FIG. 1B. Especially the areal region width 15 and the areal region length 16 of at least one areal region (1 and/or 2) of the composite 3 can be varied according to the particular requirements by means of the applicator appliance 7 of FIGS. 1A and 1B.

For this, at least one extrudate is conveyed by a plurality of conveying appliances/metering pumps disposed on a (pump) block 40 in those coextrusion chambers (19A to 19F) which are involved in the application of composite 3 to the substrate 13. The pump block 40 is shown by FIG. 1B to be driven by one or more drives 41. Circulation modules 43 upstream of the coextrusion chambers can be switched via fluidic switch elements such as, for instance, valves such that an extrudate can circulate in the applicator appliance 7 and/or the conveying appliance 22. Circulating the normally heated extrudate stops the lines and channels from gumming up and ensures that the extrudate is always conveyable. Channels and line are schematically indicated in FIG. 1B by broken lines.

Switching one of the circulation modules 43, each of which is assigned to a coextrusion chamber (19A to 19F) such that the extrudate(s) circulate means that the circulating extrudate is not conveyed into the coextrusion chamber. The extrudate is conveyed back into the pumps and circulates in the applicator appliance 7. The application of the circulating extrudate is thus interrupted in the region of the assigned coextrusion chamber. Accordingly, application interruption for variation of areal region width 15 and/or of areal region length 16 is effected by fluidic cooperation of pump block 40 with the circulation modules 43 or, to be more precise, by switching the fluidic switch element in individual or two or more circulation modules 43 in accordance with the particular requirements. When a circulation module 43 is switched such that the extrudate does not circulate but is conveyed to the outlet 24 of applicator appliance 7, application of the extrudate takes place in the region of the coextrusion chamber fluidically assigned to circulation module 43.

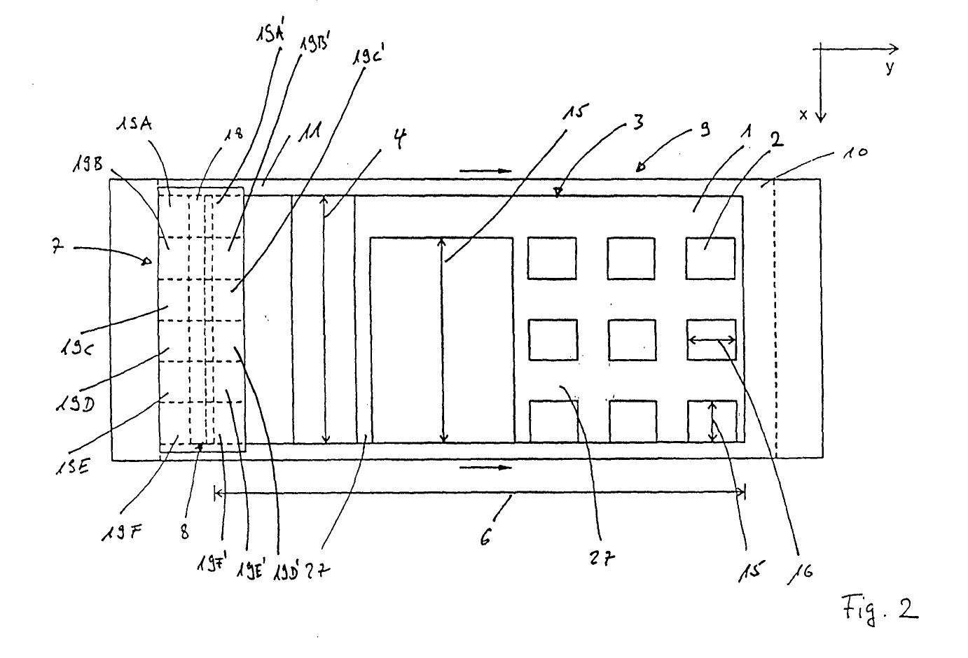

FIG. 2 shows a schematic plan view of a device for producing and/or applying an essentially two-dimensional composite 3 formed of at least two layers 1, 2 in predeterminable composite width 4, predeterminable composite height 5 and/or predeterminable composite length 6. It is also apparent in FIG. 2 that the coextrusion die 8 used for application is formed as a wide-slot die whose die-slot length determines virtually the maximum composite width 4. The transport direction y therein is defined by the transporting appliance 9, the transport direction y being essentially parallel to the composite length 6 and essentially perpendicular to the composite width 4 and/or to the composite height 5. The device of FIG. 2 makes it possible to adjust the composite width 4, the composite length 6 and/or the composite height 5. This is accomplished because the coextrusion die 8 comprises a coextrusion channel 18 having a plurality of coextrusion chambers 19A to 19F. Each and every one of the coextrusion chambers 19A to 19F has a first inlet 20 for the first extrudate 21, which forms the first layer 1, and a second inlet 20′ for the second extrudate 21′, which forms the second layer 2. Every one of the inlets 20, 20′ of every one of the coextrusion chambers 19A to 19F is shown by FIG. 2 to be fluidically assigned a conveying device 22. The fluidic assignment of the conveying appliances 22 to each and every inlet 20, 20′ of each and every chamber 19A to 19F renders the layered structure parameters of the entire applied material 3 adjustable in a varied manner. For instance, by specifically controlling individual conveying appliances 22 it is possible to control the feed of the first and/or optionally of the second extrudate 21, 21′ in a time-dependent manner, generating in effect an applied material which portionally has different areal region/areal region parameters. Areal region parameters include the areal region thickness (layer height 17) as well as the areal region width 15 and the areal region length 16.

FIG. 2 by way of example depicts a composite structure comprising the formation, at irregular intervals relative to the composite width 4 and the composite length 6, of portions 37 having a first and a second layer 1, 2 and also portions having just one first layer 1.

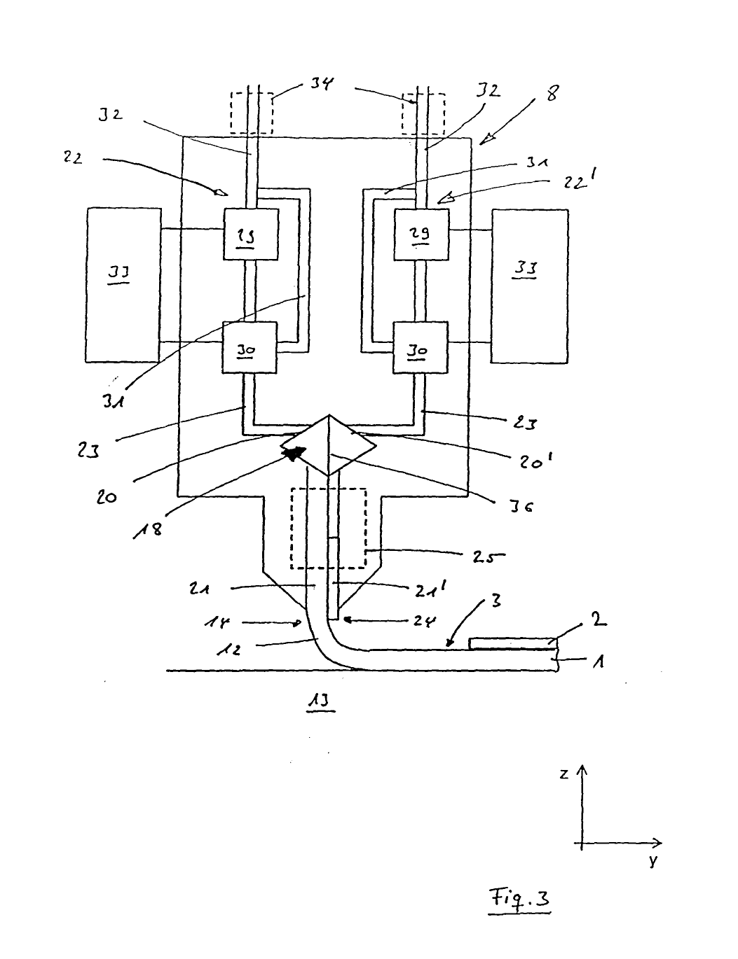

FIG. 3 shows a schematic depiction of an applicator die 8 in vertical section. The applicator die 8 depicted therein can be provided in a device according to FIG. 1A, 1B or 2, for example. It accordingly serves to generate and/or apply a two-dimensional multilayered material 3 formed of a coextrudate 14, preferably on a transport area 11 of a transporting appliance 9 or on a substrate 13. The applied material is shown in FIG. 3 to be formed of a first extrudate 21 and of a second extrudate 21′. The first extrudate 21 forms the first areal region/first layer 1 of composite material 3 while the second extrudate 21′ forms the second areal region/layer 2. The applicator die 8 of FIG. 3 comprises a first inlet 20 for the first extrudate 21 and a second inlet 20′ for the second extrudate 21′. Every one of the inlets 20, 20′ is in communication with a channel or line 23. An extrudate pressure between about 10 and about 100 bar can prevail in the lines 23 and/or in the die 8. The temperature of the extrudates 21, 21′ can be greater than 60° C. More particularly, the extrudates 21, 21′ can have temperatures between about 100° C. and about 220° C. An outlet 24 for the coextrudate 14 is provided on the underside of coextrusion die 8. A heater 25 is disposed in the region of the outlet 24 to render the outlet 24 and thus also the coextrudate 14 leaving the outlet 24 heatable. The coextrusion wide-slot die 8 of FIG. 3 can be used to alter the application width of the material leaving the outlet 24. The application width is not more than the maximum application width which is essentially defined by the width of the outlet 24. The material is applied portionally in FIG. 3, so the portions of the applied material have strip-shaped interruptions 27.

The coextrusion die 8 of FIG. 3 comprises a plurality of conveying appliances 22 for conveying the extrudates 21, 21′, which are each in fluidic communication with the first inlet 20 and the second inlet 20′. The conveying appliances 22 can be for example disposed in a block (not depicted in FIG. 3), in which case each and every conveying appliance may comprise a (metering) pump. The (pump) block may comprise a conjoint drive 41 which drives each and every metering pump of the conveying appliance 22. The drive may comprise one or more motors.

The first inlet 20 and the second inlet 20′ are shown by FIG. 3 to empty into a coextrusion channel 18 which—as depicted in FIG. 2—can be subdivided into a plurality of coextrusion chambers 19A to 19F.

FIG. 3 shows that every one of the conveying appliances 22 which is in fluidic communication with the inlets 20, 20′ comprises a pump 29, a switch element formed as a valve 30 and a fluidic return line 31 which bypasses the pump 29 and is switchable by the valve 30. If no extrudate 21, 21′ is to be conveyed into the inlet 20, 20′, the valve 30 is switched such that the extrudate 21, 21′ conveyed by the pump 29 is returned, via the return line 31, into the feed line 32 connected to the pump 29. This accordingly short-circuits the conveyance of extrudate 21, 21′ to ensure that both the conveyance velocity and the feed pressure of the circulating extrudate remain essentially constant. If the conveyance of the extrudate is to be continued, the valve 30 is switched such that the extrudate 21, 21′ is conveyed into the inlet 20, 20′ via the line 23 connected thereto. The valve 30 and the return line 31 can be constituent parts of a circulation module (43). Each and every conveying appliance 22 can be assigned a separate circulation module 43. The circulation module 43 is capable of effectuating an interruption to the application of the extrudate (21 or 21′), alternatively the extrudates (21 and 21′), without the operation of one or all pumps 29 of the conveying appliances 22 having to be interrupted. This is particularly advantageous when the pumps 29 of the conveying appliance 22 are actuated by a conjoint drive 41. The conjoint drive 41 is in sustained operation and the interruption or (temporary) deactivation of the application of the extrudates 21, 21′ is effected by controlling one or more switch elements 30 in one or more circulation modules 43 so that the extrudate 21, 21′ (the extrudates 21 and/or 21′) are not conveyed through the outlet 24 from the applicator die 8, but circulate within the applicator appliance 7. By switching the extrudate (21, 21′) between through-flow and circulation it is possible to alter, for example, the application width, the application length and/or further application parameters.

Control appliances 33 are provided according to FIG. 3 to render each and every conveying appliance 22 controllable. The conveying appliances 22 can thereby be switched and/or controlled portionally so the applied material will have one, two or no layers 1, 2 as required. Because every one of the conveying appliances 22 is separately and preferably mutually independently controllable, especially open and closed loop controllable, the layer width 15, the layer length 16 and/or the layer height 17 of one or more layers 1, 2 of the applied material are alterable.

To stabilize the flow behavior of the extrudates 21, 21′, every one of the inlets 20, 20′ or, alternatively, only one inlet (20 or 20′) can be assigned a preferably electric heating device 34.

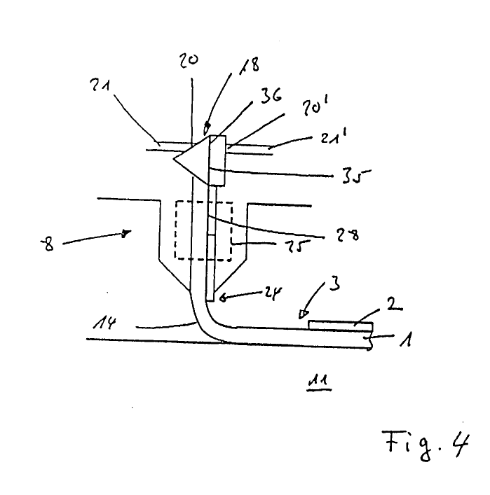

A detailed view of an alternative design of a coextrusion die 8 as per FIG. 3 can be seen in FIG. 4. Coextrusion die 8 is shown therein to comprise a coextrusion channel 18 into which the first and second inlets 20, 20′ empty and to which the outlet 24 of the coextrusion die 8 is connected.

According to FIG. 4, the second inlet 20′ empties into the coextrusion channel 18 such that the second extrudate 21′ is disposable at an extrudate surface 35 formed by the first extrudate 21. It is accordingly possible to drive the second extrudate 21′ against the extrudate surface 35, formed in the coextrusion channel 18, of the first extrudate 21. This is particularly advantageous when the layer 1 formed by the first extrudate 21 is distinctly thicker than the layer 2, formed by the second extrudate 21′. As a result of the thicker first layer 1, formed by the first extrudate 21, being conveyed through the coextrusion channel 18 at a conveyance velocity and as a result of the second, thinner layer 2, formed of the second extrudate 21′, being driven against the first layer 1, the second layer 2 will attach to the first layer 1 so that the second layer 2 is endowed with the conveyance velocity of the first layer 1.

FIG. 4 reveals a dividing wall 36 which extends at least regionally into the coextrusion channel 18 of the coextrusion die 8. The dividing wall 36 can augment the flow properties of the extrudates 21, 21′ in that premature commixing of the extrudates 21, 21′ in the region of the adjacent inlets 20, 20′ is avoided.

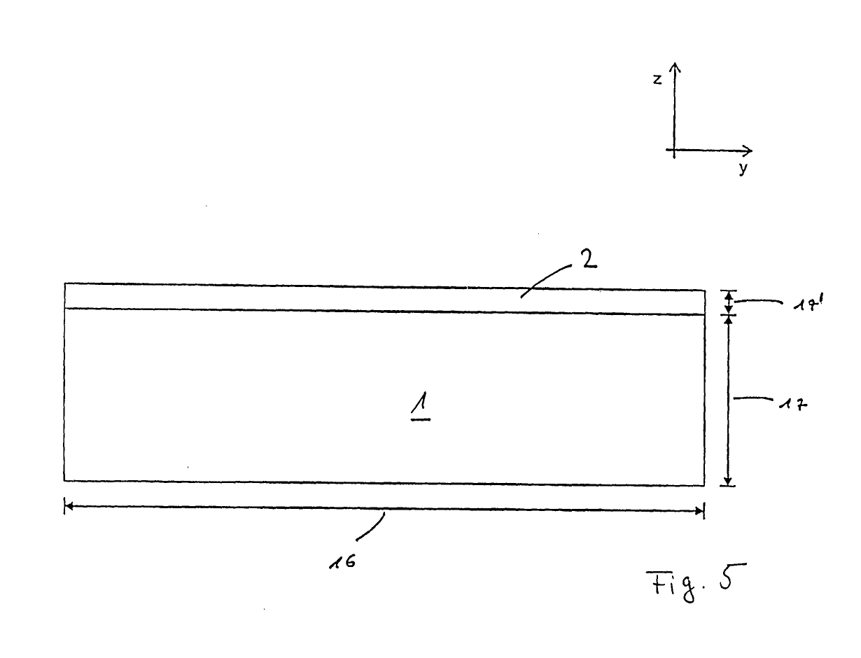

FIG. 5 shows a two-dimensional composite 3 obtained using a device as per FIGS. 1A and 2 or, more precisely, using a coextrusion die 8 as per FIGS. 3 and 4. It can be seen in FIG. 5 that the composite 3 consists of a first areal region 1 and of a second areal region 2 disposed on the first areal region 1, the first areal region 1 being formed of a first extrudate 21 and the second areal region 2 being formed of a second extrudate 21′. The two areal regions 1, 2 are in layer-type disposition. The second layer 2 is a function layer and the first layer 1 is an effect layer, which augments the effect of the function layer. The function layer may be an adhesive layer. This adhesive layer may be durably adhesive or only after some reactivation, for example with a solvent such as, for instance, water, with a heated roll or with an infrared radiator (IR radiator).

The effect layer 1 may optionally have adhesive properties. The effect layer 1 may additionally have a volume-filling or an acoustically and/or mechanically damping property. The effect layer 1 may also have a flameproofing property or a barrier property. If the effect layer 1 has adhesive properties, it can augment the adhesive properties of the adhesive/function layer 2. More particularly, the adherence of the second layer 2 to an adherend material but also to the first layer 1 and/or the adherence of the first layer 1 to a substrate 13 or any desired surface can be augmented as a result.

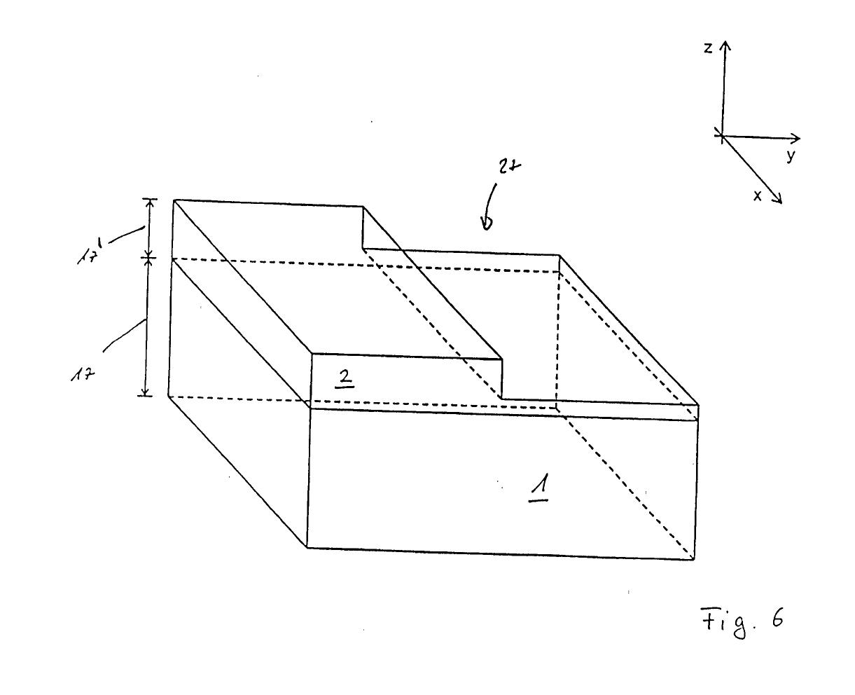

FIG. 6 shows a vertical section through a composite of FIG. 5. It can be seen in FIG. 6 that the second layer 1, which forms an adhesive layer, is thinner than the first layer 1, which forms an effect or filling layer. That is, the layer height 17′ of the second layer 2 is less than the layer height 17 of the first layer 1. For example, the second layer 2 can have a layer height 17′ in a range between about 1 μm and about 10 μm, preferably about 3 μm The first layer 1 can for example have a layer height 17 in a range between about 5 μm and about 5 mm, preferably about 15 μm. Both layers 1, 2 can be formed of a hot-melt adhesive, in which case the thinner, second layer 2 is formed of a high-value adhesive and the thicker, first layer 1 is formed of a lower-value adhesive, the adhesive properties of which are less effective than those of the thinner, second layer 2. The thicker, first layer 1 can work as an effect layer 1 to serve the purpose of smoothing out unevennesses 38 on the adherend surface in that the volume of the first, thicker layer 1 fills out the surface unevennesses 38. This filling function of the first, thicker (effect) layer 1 contributes to the higher-value, thinner second layer 2 having better, i.e., more effective, adherence on the adherend surface.

The function layer depicted as per FIG. 6 can be formed of an EVA, for example, and the effect layer disposed thereunder can be formed of a UV-acrylate. The method which the present invention provides of coextruding and then applying the extrudates with or without cooling or hardening is a straightforward way to produce the composite of these materials.

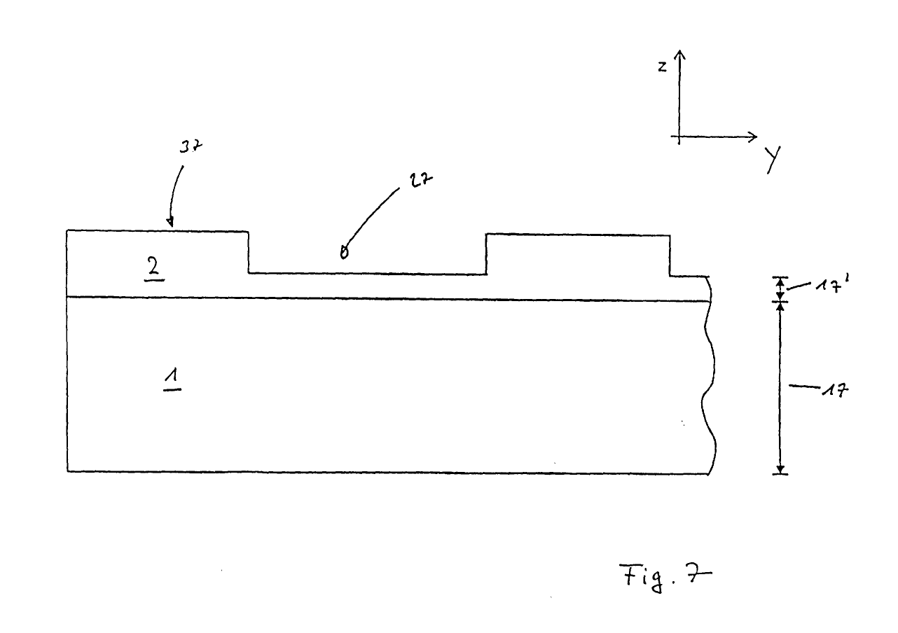

FIG. 7 shows a composite 3 where there is a sequence of layers formed of different materials. More particularly, the different layers 1, 2 in FIG. 7 are formed of different adhesives. The upper, thinner adhesive layer 2 has an weakening 27, which is marked by a portional reduction in layer height 17. The adhesive is less efficient at the weakening, i.e., the composite has worse adherence there.

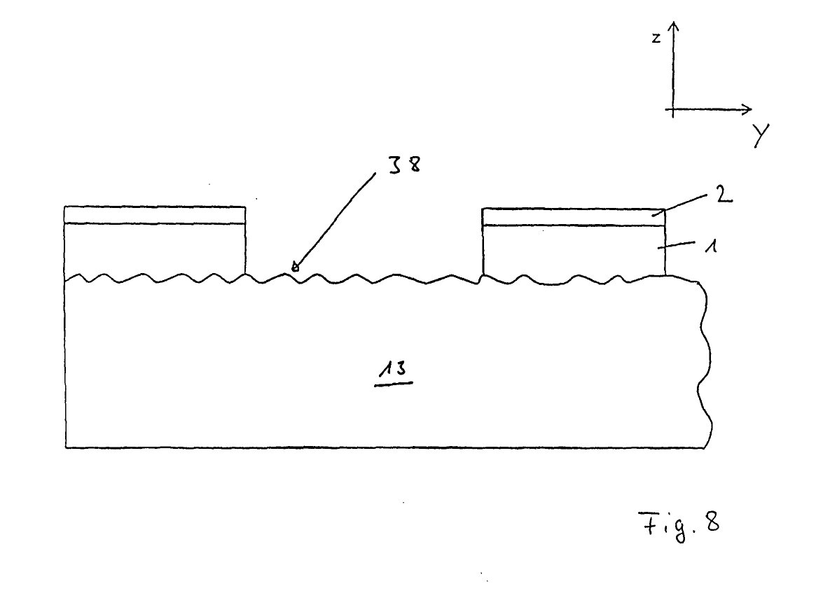

A composite 3 disposed on a substrate 13 is shown in FIG. 8. The second layer 2 is disposed on the first layer 1 and the first layer 1 is directly disposed on the substrate 13. The substrate 13 can be formed for example of a foil or of a paper, for example a silicone paper.

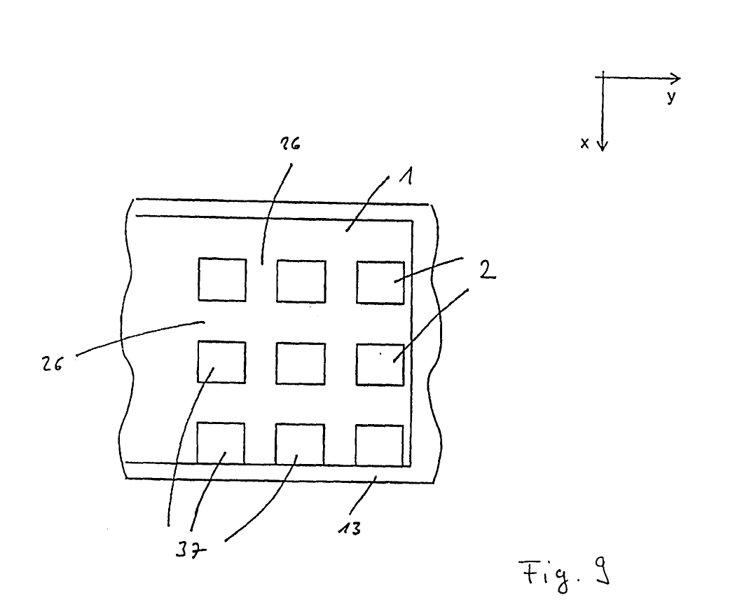

FIG. 9 shows a schematic plan view of a composite 3. It can be seen that the first areal region 1 extends across the full length 6 and across the full width 4 of composite 3. The second areal region 2 is portionally disposed on the first areal region 1 such that strip-shaped interruptions 26 are disposed in each case between the portions 37 of the second areal region 2 in both the longitudinal direction y and in the transverse direction x. Where there are interruptions 26, the composite 3 has no or less adhesive properties relative to the adhesive properties of the portions 37 of the second areal region 2 disposed on the first areal region 1.

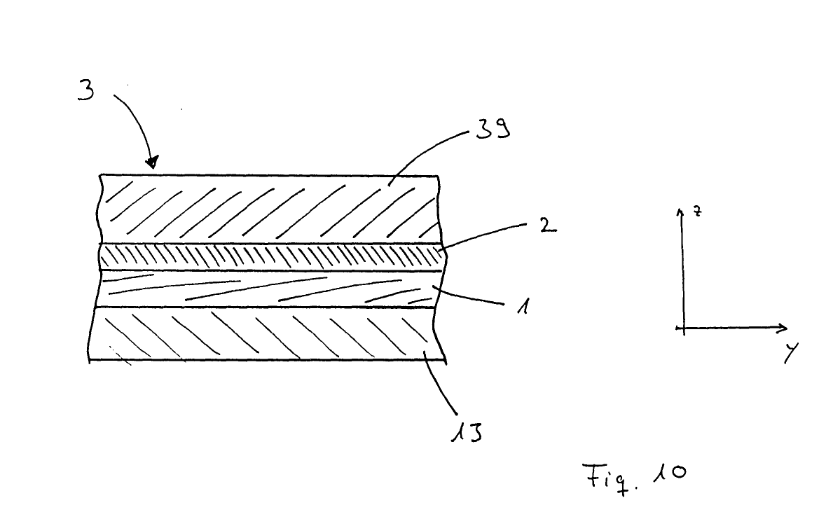

FIG. 10 shows a schematic section through a four-ply composite 3 in the vertical direction (i.e., in the z-direction). The effect layer 1 (first areal region) and the function layer 2 (second areal region) have been applied to a substrate 13, formed of a polymeric foil for example, such that the effect layer 1 is disposed on the substrate 13 and the function layer 2 is disposed on the effect layer 1. The effect layer 1 may comprise for example an inorganic adhesive which is firmly adherent to the substrate 13. In order for a third areal region 39 to be adherently disposable on the function layer 2, the function layer 2 can comprise an organic adhesive, in which case the third areal region 39 can be formed in a layer-type manner of a fibrous material in particular. The result is a configuration wherein the first and second areal regions 1, 2 are disposed between the substrate 13 and the third areal region 39.

The configuration of the composite as per FIG. 10 is useful, for example, for (glass fiber) wallpapers. Said composite can be created by conveying the substrate 13 in a transport direction y while the areal regions 1 and 2 are applied to the substrate 13 by an above-described coextrusion process. All the while, the third areal region is applied to the substrate 13, for example via a roll or an alternative feeding appliance, at a point which, relative to the transport direction y, is downstream of the point where the coextrudate is applied. The four plies 13, 1, 2 and 39 can thereby be applied on top of each other in one operation in that, in particular, the third areal region 39 is applied in-line, i.e., during the production of the plies 13, 1 and 2.

LIST OF REFERENCE SIGNS

| | |
|---|---|
| 1 | first areal region |
| 2 | second areal region |
| 3 | composite |
| 4 | composite width |
| 5 | composite height |
| 6 | composite length |
| 7 | applicator appliance |
| 8 | applicator die, coextrusion |
| | wide-slot die |
| 9 | transporting appliance |
| 10 | transportation belt |
| 11 | transport area |
| 12 | extrudate curtain |
| 13 | substrate |
| 14 | coextrudate |
| 15 | areal region width |
| 16 | areal region length |
| 17, 17′ | areal region height |
| 18 | coextrusion channel |
| 19A . . . 19F | coextrusion chambers |
| 19A′ . . . 19F′ | coextrusion chambers |
| 20 | first inlet |
| 20′ | second inlet |
| 21 | first extrudate |
| 21′ | second extrudate |
| 22 | conveying appliance |
| 22′ | conveying appliance |
| 23 | line |
| 24 | outlet |
| 25 | heating |
| 26 | interruption |
| 27 | weakening |
| 28 | cooling appliance |
| 29 | pump |
| 30 | switch element |
| 30A | valve |
| 30B | return line |
| 32 | feed line |
| 33 | control appliance |
| 34 | heating device |
| 35 | extrudate surface |
| 36 | dividing wall |
| 37 | portion |
| 38 | unevennesses |
| 39 | third areal region |
| 40 | pump block |
| 41 | drive |
| 43 | circulation module |
| x | transverse direction |
| y | transport direction, |
| | longitudinal direction |
| z | vertical direction |

1. A device for producing and/or applying an essentially two-dimensional composite formed of at least two areal regions in predeterminable composite width, predeterminable composite height and/or predeterminable composite length, said device comprising a transporting appliance having a transport area and defining a transport direction and also an applicator appliance having an applicator die, which includes a slot-shaped outlet disposed essentially transversely to the application direction and with which the first areal region comprising a first extrudate and the second areal region comprising a second extrudate is extrudable onto the transport area, characterized in that the applicator die comprises at least one conveying appliance for conveying an extrudate onto the transport area, wherein the conveyed volume, the conveyed mass, the conveyance velocity and/or the metering time of at least one of the extrudates is controllable using the conveying appliance.

2. The device as claimed in claim 1, characterized in that the conveying appliance comprises at least one pump for conveying an extrudate.

3. The device as claimed in claim 1, characterized in that the conveying appliance comprises at least one switch element which preferably includes a valve and/or a return line so that the extrudate conveyed by the conveying appliance is circulatable within the applicator appliance or within at least one of the conveying appliances.

4. The device as claimed in claim 1, characterized in that the composite width and/or the composite length and/or the composite height is at least portionally adjustable using the conveying appliance of the applicator die.

5. The device as claimed in claim 1, wherein each and every areal region of the composite has an areal region width, an areal region length and an areal region height, characterized in that the areal region width, the areal region length and/or the areal region height of one or more areal regions is at least portionally alterable during the coextrusion of the composite specifically by the at least one conveying appliance.

6. A coextrusion die for generating and/or applying a two-dimensional application of a composite, in particular for an applicator appliance of a device as defined in claim 1, wherein the composite is formed of a coextrudate comprising a first and at least a second extrudate, and comprises a first areal region formed of the first extrudate and a second areal region formed of at least the second extrudate, and wherein the coextrusion die has a first inlet for the first extrudate a second inlet for the second extrudate and an outlet which comprises a slot-shaped orifice, which determines the composite width of the composite and which is intended for the coextrudate, characterized by at least one integrated conveying appliance which is in fluidic communication with one or more inlets and with which at least one extrudate is conveyable through the coextrusion die to the outlet, and with which the conveyed volume, the conveyed mass, the conveyance velocity and/or the metering time of at least one of the extrudates is controllable.

7. The coextrusion die as claimed in claim 6, characterized in that at least one of the conveying appliances comprises at least one pump and at least one switch element which includes a valve and at least one fluidic, preferably switchable return line which bypasses the pump.

8. The coextrusion die as claimed in claim 6, characterized by means with which the application of the composite material is effected portionally in lengthwise and widthwise directions so that portions of the applied material have strip-shaped interruptions.

9. The coextrusion die as claimed in claim 6, characterized by a coextrusion channel into which the first and second inlets empty and to which the outlet is connected.

10. The coextrusion die as claimed in claim 9, characterized in that the width of the outlet and/or the composite width of the composite and/or at least one portion of the composite is alterable.

11. The coextrusion die as claimed in claim 9, characterized in that the second inlet empties into the coextrusion channel such that the second extrudate is disposable at an extrudate surface formed by the first extrudate.

12. The coextrusion die as claimed in claim 9, characterized in that the coextrusion channel comprises a plurality of coextrusion chambers.

13. The coextrusion die as claimed in claim 12, characterized in that each and every coextrusion chamber of the coextrusion channel is in each case in fluidic communication with at least one conveying appliance.

14. The coextrusion die as claimed in claim 13, wherein the first and second areal regions each have an areal region width and an areal region length which define a plane parallel to an application area and wherein the first and second areal regions each have an areal region height extending essentially perpendicularly to the application area, characterized in that each and every one of the conveying appliances is assigned a control appliance so that each and every one of the conveying appliances is separately and preferably mutually independently controllable, especially open and closed loop controllable, whereby the areal region width, the areal region length and/or the areal region height of one or more areal regions of the applied material is/are at least portionally alterable.

15. The coextrusion die as claimed in claim 14, characterized in that the composite width of the composite is alterable by connecting and/or disconnecting one or more of the conveying appliances which are fluidically assigned to one or more coextrusion chambers disposed edge-sidedly in relation to the width of the outlet, and in that the composite length of the composite or of the areal regions is alterable by connecting and/or disconnecting all the conveying appliances.

16. The coextrusion die as claimed in claim 6, characterized in that the first inlet and/or the second inlet is assigned a, preferably electrical, heating device, whereby the extrudates are heatable, in particular liquefiable, and/or kept liquid.

17. The coextrusion die as claimed in claim 6, characterized by at least one pressure sensor with which the pressure of at least one extrudate is measurable.

18. A process for applying and/or producing a two-dimensional composite on a moving transport area of a transporting appliance (9), said process comprising the formation of the composite from an applied material comprising a first areal region and at least a second areal region, wherein the composite has a composite width, a composite length and a composite height, characterized in that the composite is particularly coextruded by a device, which preferably comprises a coextrusion die, from a first extrudate forming the first areal region and at least one second extrudate forming the second areal region, each and every one of the areal regions of the composite having an areal region length, areal region width and areal region height and the areal region widths and/or the areal region lengths and/or the areal region heights of the first and/or of the second areal region and/or the composite width, and/or the composite length and/or the composite height of the composite being altered during the coextrusion by the delivered mass and/or the delivered mass per unit time and/or the delivered volume and/or the delivered volume per unit time of the first and/or of the second extrudate being altered at least portionally and/or at least temporally.

19. A process as defined in the preamble of claim 18, characterized in that the composite is coextruded from a first extrudate forming the first areal region and at least one second extrudate forming the second areal region such that the second extrudate is conveyed in a coextrusion die having a coextrusion channel, in particular in accordance with a device which preferably comprises a coextrusion die against the extrudate surface of the first extrudate conveyed into the coextrusion channel, whereby the second extrudate is adherently placed onto the extrudate surface of the first extrudate in the coextrusion channel of the coextrusion die.

20. The process as claimed in claim 18, characterized in that the areal region width and/or the areal region length and/or the areal region height of one of the areal regions is altered while the areal region width, the areal region length and the areal region height of at least one of the other areal regions are at least portionally and/or at least temporally retained.

21. The process as claimed in claim 18, characterized in that the conveying of at least one of the extrudates is effected with temporal interruptions.

22. The process as claimed in claim 21, characterized in that the temporal interruptions to the conveying of the second extrudate are temporally coincident with interruptions to the conveying of the first extrudate.

23. The process as claimed in claim 18, characterized in that the transporting appliance and/or the transport area are at least portionally cooled.

24. A two-dimensional composite obtained in particular with a device as consisting of a first areal region and at least one second areal region disposed on the first areal region, wherein the first areal region is formed of a first extrudate and the second areal region is formed of a second extrudate, preferably using a coextrusion die characterized in that the second areal region comprises a function region, especially an adhesive region, and in that the first areal region is formed as an effect region, wherein the effect region has adhesive, volume-filling, acoustically dampening and/or mechanically dampening properties, a flameproofing property or a barrier property.

25. The composite as claimed in claim 24, characterized in that the effect region augments the property of the function region, in particular the adhesive property of the function region.

26. The composite as claimed in claim 24, wherein the first and second areal regions are each defined by an areal region width, an areal region length and an areal region height, characterized in that the areal region width and/or the areal region length and/or the areal region height of the first and/or second areal regions varies at least portionally across the composite length and/or the composite width and/or the composite height of the composite.

27. The composite as claimed in claim 24, characterized in that the first and second areal regions are formed of different materials, in particular of different adhesives, and/or in that the first and/or second areal regions is formed of a hot-melt adhesive which is preferably chemically or radiation-crosslinkable, reactivatable, durably tacky and/or water-soluble.
